(19) United States
(12) Patent Application Publication
(10) Pub. No.: US 2013/0071008 A1
(43) Pub. Date: Mar. 21, 2013

(54) IMAGE CONVERSION SYSTEM USING EDGE INFORMATION

(71) Applicants: Liang-Gee Chen, Tainan City (TW); Chung-Te Li, Tainan City (TW); Chao-Chung Cheng, Tainan City (TW); Ling-Hsiu Huang, Tainan City (TW)

(72) Inventors: Liang-Gee Chen, Tainan City (TW); Chung-Te Li, Tainan City (TW); Chao-Chung Cheng, Tainan City (TW); Ling-Hsiu Huang, Tainan City (TW)

(73) Assignees: NATIONAL TAIWAN UNIVERSITY, Taipei (TW); HIMAX TECHNOLOGIES LIMITED, Tainan (TW)

(21) Appl. No.: 13/233,048

(22) Filed: Sep. 15, 2011

(51) Int. Cl. G06K 9/00

(52) U.S. Cl. 382/154

(57) ABSTRACT

In accordance with at least some embodiments of the present disclosure, a process for converting a two-dimensional (2D) image based on edge information is described. The process may include partitioning the 2D image to generate a plurality of blocks, segmenting the plurality of blocks into a group of regions based on edges determined in the plurality of blocks, assigning depth values to the plurality of blocks based on a depth gradient hypothesis associated with the group of regions, wherein pixels in each of the plurality of blocks are associated with a same depth value, and generating the depth map based on the depth values of the plurality of blocks.

### BACKGROUND OF THE DISCLOSURE

1. Field of the Disclosure

Embodiments of the present disclosure relate generally to video signal processing technologies and more specifically to image conversion systems using edge information.

2. Description of the Related Art

Unless otherwise indicated herein, the approaches described in this section are not prior art to the claims in this application and are not admitted to be prior art by inclusion in this section.

In three-dimensional (3D) images, a depth map contains information relating to the distance of the surfaces of scene objects from a viewpoint. Since two-dimensional (2D) images lack any depth maps, one of the steps in performing 2D-to-3D conversion involves generating a depth map from 2D images. Existing depth map generation approaches are faced with at least two challenges. One is to maintain depth uniformity inside an object, and the other is to retrieve appropriate depth relationships among all objects. Some of the existing approaches use motional parallax as the primary depth due. Other approaches may follow the sequence of segmenting objects, detecting the depth information among the objects, and then assigning the depth information to a depth map. These approaches may obtain false depth information or may be prohibitively costly to implement.

### SUMMARY

In accordance with one or more embodiments of the present disclosure, a process for converting a two-dimensional (2D) image based on edge information may be presented. The process may be implemented to partition the 2D image to generate a plurality of blocks, segment the plurality of blocks into a group of regions based on edges determined in the plurality of blocks, and assign depth values to the plurality of blocks based on a depth gradient hypothesis associated with the group of regions, wherein pixels in each of the plurality of blocks are associated with a same depth value. The process may further be implemented to generate the depth map based on the depth values of the plurality of blocks.

In accordance with other embodiments of the present disclosure, a machine readable medium containing instructions for converting a 2D image based on edge information may be presented. The instructions may include partitioning the 2D image to generate a plurality of blocks, segmenting the plurality of blocks into a group of regions based on edges determined in the plurality of blocks, assigning depth values to the plurality of blocks based on a depth gradient hypothesis associated with the group of regions, wherein pixels in each of the plurality of blocks are associated with a same depth value, and generating the depth map based on the depth values of the plurality of blocks.

In accordance with other embodiments of the present disclosure, a process for converting a 2D video based on edge information may be present. The process may be implemented to select a 2D image from the 2D video and partition the 2D image to generate a plurality of blocks, wherein each pair of the plurality of blocks is connected by a link having a link value. The process may further be implemented to segment the plurality of blocks into a group of regions based on the link values, assign depth values to the plurality of blocks by applying a depth gradient hypothesis associated with the group of regions, generate the depth map based on the depth values of the plurality of blocks, and convert the 2D image to a 3D image for the 3D video using the depth map.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a block diagram of an illustrative embodiment of a system configured to perform 2D-to-3D conversion operations;

FIG. 2 shows an illustrative embodiment of a depth map generator configured to generate a depth map based on a 2D image;

FIG. 3 illustrates an example of generating a filtered depth map from a 2D image; and

FIG. 4 shows a flow diagram of an illustrative embodiment of a process for converting a 2D image to a 3D image, all arranged according to at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

This disclosure is drawn, inter alia, to methods, systems, and computer programs related to image conversion using edge information. Throughout the disclosure, the term “depth map” may broadly refer to a data structure that contains depth values, or information relating to the distance of the surfaces of objects from a viewpoint. A 2D image may be captured from a particular viewpoint. The 2D image may be analyzed to estimate the depth values associated with the pixels in the 2D image. Each depth value may relate to a distance from a pixel of an object to the viewpoint. For example, the further away the object is from the viewpoint, the longer the distance is between the object and the viewpoint. In one implementation, a longer distance between the object and the viewpoint may correspond to a smaller depth value. In an alternative implementation, a longer distance between the object and the viewpoint may correspond to a larger depth value. The depth values for all the pixels in the 2D image may be stored in the depth map. For example, if the 2D image has a resolution of 1024×768, the depth map may also include 1024×768 corresponding depth values for the pixels in the 2D image.

The term “depth gradient hypothesis” may broadly refer to a certain hypothesis about how the depth values in the 2D image may change and in which orientation. Some example depth gradient hypotheses include bottom-to-top, top-to-bottom, left-to-right, right-to-left, bottom-left-to-top-right, and bottom-right-to-top-left hypotheses. A bottom-to-top depth gradient hypothesis may refer to the pixels in the bottom portion of the 2D image having larger depth values, implying a shorter distance between the object and the view point, and the pixels in the top portion of the 2D image having smaller depth values, implying a longer distance between the object and the viewpoint. A top-to-bottom depth gradient hypothesis, on the other hand, may refer to the pixels in the top portion of the 2D image having larger depth values, and the pixels in the bottom portion of the 2D image having smaller depth values. Similarly, a left-to-right depth gradient hypothesis may refer to the pixels in the left portion of the 2D image having larger depth values, and the pixels in the right portion of the 2D image having smaller depth values. A right-to-left depth gradient hypothesis may refer to the pixels in the right portion of the 2D image having larger depth values, and the pixels in the left portion of the 2D image having smaller depth values. A bottom-left-to-top-right depth gradient hypothesis may refer to the pixels in the bottom-left corner portion of the 2D image having larger depth values, and the pixels in the top-right corner portion of the 2D image having smaller depth values. A bottom-right-to-top-left depth gradient hypothesis may refer to the pixels in the bottom-right corner portion of the 2D image having larger depth values, and the pixels in the top-left corner portion of the 2D image having smaller depth values.

The “minimum spanning tree” (MST) segmentation algorithm generally refers to a known graph-based method. An image may be converted to a graph, so that each node in the graph corresponds to pixels, and two nodes are connected in a unidirectional manner by a link. Each link has a link value, which corresponds to an edge determined between the two connected nodes. The MST segmentation algorithm is an approach to group pixels that are similar and are connected. Additional details and examples are further provided in subsequent paragraphs.

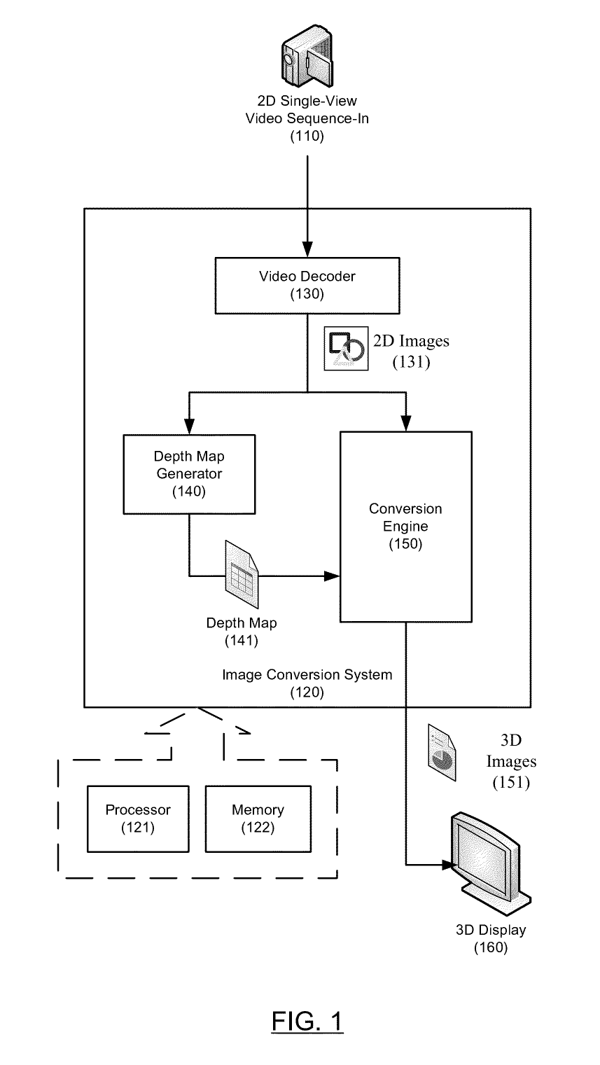

FIG. 1 shows a block diagram of an illustrative embodiment of a system configured to perform 2D-to-3D conversion operations. In particular, an image conversion system 120 may be configured to process a 2D single-view video sequence-in 110 (“2D video 110”) and generate a set of enhanced 2D single-view video sequence-out 155 for a display 160 to display. The image conversion system 120 may be configured to include, without limitation, a video decoder 130, a depth map generator 140, a conversion engine 150, a processor 121, and/or a memory 122. The depth map generator 140 may generate a depth map 141 based on a 2D image 131, and the conversion engine 150 may generate a 3D image 151 based on the generated depth map 141.

In some embodiments, the 2D video 110 may correspond to a video stream generated by 2D video capturing devices such as camcorders or a video stream converted from a 2D movie. The 2D video 110 may contain a sequence of image frames, each of which may include a still 2D single-view color image. Such a 2D single-view image may contain monoscopic imaging data that does not have depth information, and thus cannot be directly used to show 3D effect without further processing. Each 2D image may have multiple color pixels configured based on a specific resolution. For example, a 2D image may have a 1024×768 resolution, meaning that the 2D image has 768 horizontal image lines, each of the image lines having 1024 pixels of color information. Other popular image resolutions may include, without limitation, 640×480, 1280×1024, or 1920×1200. In some embodiments, the 2D video 110 may be in a compressed and encoded format such as, without limitation, MPEG-2.

In some embodiments, the video decoder 130 may decompress and decode the 2D video 110 and extract a set of the 2D images 131 from the 2D video 110. The extracted 2D image 131 may then be transmitted to the depth map generator 140 and the conversion engine 150 for further processing. The 2D images 131 may be stored in a frame buffer (not shown in FIG. 1), which may allow the depth map generator 140 and the conversion engine 150 to quickly access these 2D images.

In some embodiments, the conversion engine 150 may be configured to receive the 2D image 131 from the video decoder 130 and also the depth map 141 associated with the 2D image 131 from the depth map generator 140. The conversion engine 150 may also be configured to generate the 3D image 151 based on the 2D image 131 and the depth map 141. The 3D image 151 may then be displayable on the display 160. The details of the depth map generator 140 and the conversion engine 150 are further described below.

In some embodiments, the image conversion system 120 may utilize the processor 121 for performing the decoding of the 2D video 110, the generating of the depth map 141, and/or the converting of the 2D images 131. The processor 121 may be a microprocessor or any general or specific processing unit that executes commands based on programmable instructions. In some embodiments, the processor 121 may utilize the memory 122 to execute the programmable instructions and store the intermediate processing results of the execution. The memory 122 may be in any form of random access memory (RAM), read-only memory (ROM), flash memory, conventional magnetic or optical disks, tape drives, or a combination of such devices.

Some examples of the display 160 may include, without limitation, a computer monitor, a device screen, a television, or a projector.

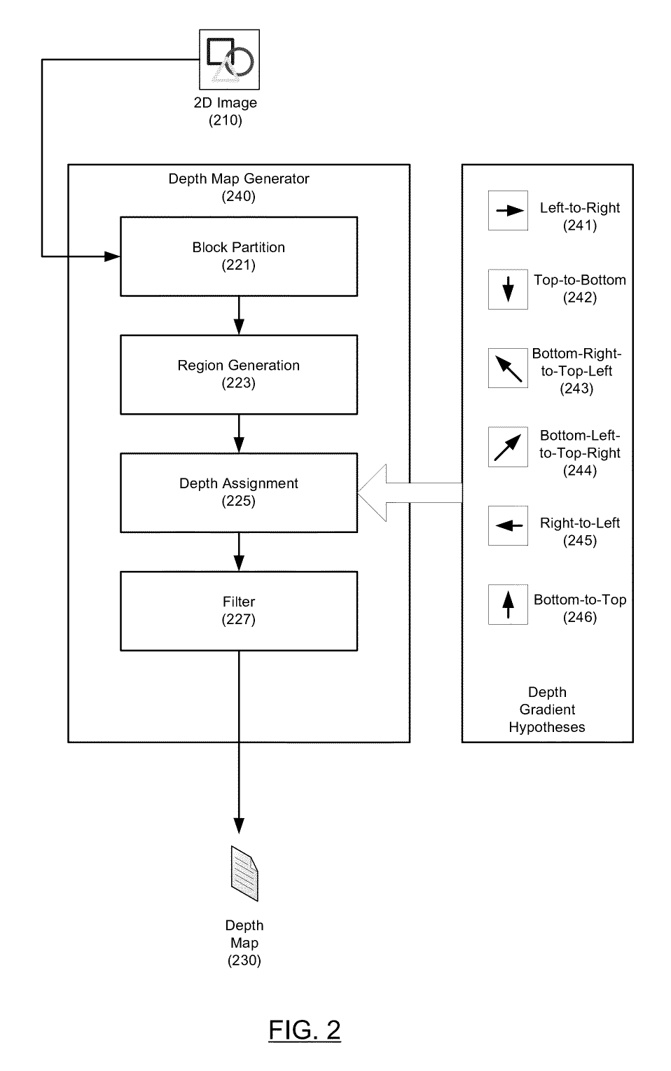

FIG. 2 shows an illustrative embodiment of a depth map generator configured to generate a depth map based on a 2D image. In FIG. 2, a depth map generator 240 (corresponding to the depth map generator 140 of FIG. 1) may contain a block division module 221, a region generation module 223, a depth assignment module 225, and a filter module 227. The depth map generator 240 may be further configured to retrieve information associated with a set of depth gradient hypotheses to generate a depth map 230.

Each of the illustrated modules may be implemented, individually and/or collectively, by a wide range of hardware, software, firmware, or any combination thereof. For example, one embodiment of the depth map generator 240 may be implemented in a set of instructions that are executed by a processing unit (e.g., processor 121), a Field Programmable Gate Array (FPGA), or other devices. In another example, some or all of the modules of the depth map generator 240 may be implemented via Application Specific Integrated Circuits (ASICs) or other integrated formats. In addition, the modules may be combined or further divided. For example, the block partition module 221 and the region generation module 223 may be combined into a single module, and the depth assignment module 225 may be further divided.

In some embodiments, the block partition module 221 may be configured to partition the 2D image 210 into blocks of pixels. For example, each block may include 4-by-4 pixels. Although the 2D image 210 does not contain depth information for each of its pixels, the region generation module 223 may be configured to group the blocks into multiple regions based on edges determined between two neighboring blocks. In one implementation, the following equation may be used:

Diff(a,b)=|Mean(a)−Mean(b)|

Here, a and b denote two neighboring blocks, and Mean(a) and Mean(b) represent the mean color of blocks a and b, respectively. The absolute difference, which corresponds to an edge or a link value, may reflect how similar the two neighboring blocks are. One example approach is to apply the MST segmentation algorithm to group the blocks into multiple regions. The MST segmentation algorithm, in one implementation, is used to remove the links having above-threshold link values (indicative of strong edges) and group the blocks having coherence in both the color differences and the connectivity. Additional details associated with applying the MST segmentation algorithm are provided in subsequent paragraphs.

After having generated the regions of the 2D image 210, the depth assignment module 225 may be configured to assign depth values to the regions based on a selected depth gradient hypothesis. Some example hypotheses, as mentioned above, include a left-to-right depth gradient hypothesis 241, a top-down depth gradient hypothesis 242, a bottom-right-to-top-left gradient hypothesis 243, a bottom-left-to-top-right gradient hypothesis 244, a right-to-left gradient hypothesis 245, and a bottom-to-top gradient hypothesis 246. In one implementation, the depth assignment module 225 may be configured to utilize the following equation:

$$Depth ( R ) = 128 + 255 ( {\sum }_{pixel ( x . y ) ∈ R} {W}_{rl} \frac{x - width / 2}{width} + {W}_{ud} \frac{y - height / 2}{height} ) / pixel\_num ( R )$$

Here, R refers to a region generated by the region generation module 223, and pixel_num(R) refers to the number of pixels in the region R. The weights also have the property of |Wᵣₗ|+|W_{ud}|=1. By varying the absolute value and sign of the weights, Wᵣₗ and W_{ud}, the above equation may be adjusted to correspond to one of the mentioned depth gradient hypotheses. In one implementation, the depth map generator 240 may be configured to analyze the geometric perspective of the 2D image 210, so that the appropriate depth gradient hypothesis (i.e., which orientation) may be selected. An example geometric perspective analysis may involve a line detection algorithm using the known Hough transform. In other words, if the 2D image 210 is determined to include objects in the bottom portion of the image that appear to be closer to a viewpoint than objects in the top portion of the image, then the bottom-to-top depth gradient hypothesis 246 may be selected. The depth assignment module 225 is then configured to use the above equation to assign the depth values to the regions generated by the region generation module 223 with Wᵣₗ set to 0 and W_{ud} set to 1. If the top-to-bottom depth gradient hypothesis 242 is selected instead, then the depth assignment module 225 is configured to also assign the depth values to the regions generated by the region generation module 223 with Wᵣₗ set to 0 and W_{ud} set to 1. Some other example values for (Wᵣₗ, W_{ud}) may include, without limitation, (−1, 0), (−0.5, 0.5), (0.5, 0.5), and (1, 0).

After the depth values have been assigned, the resulting depth map may include blocky artifacts. In some embodiments, the filter 227, having the characteristics of smoothing the depth map while still preserving the depth discontinuities along object boundaries, may be utilized. Some examples of the filter 227 may include, without limitation, a cross bilateral filter, an object-boundaries-oriented filter, and others. An example object-boundaries-oriented filter may be configured to detect boundaries using spatial frequency transforms and use the detected boundaries as constraints to reduce noise associated with the depth map.

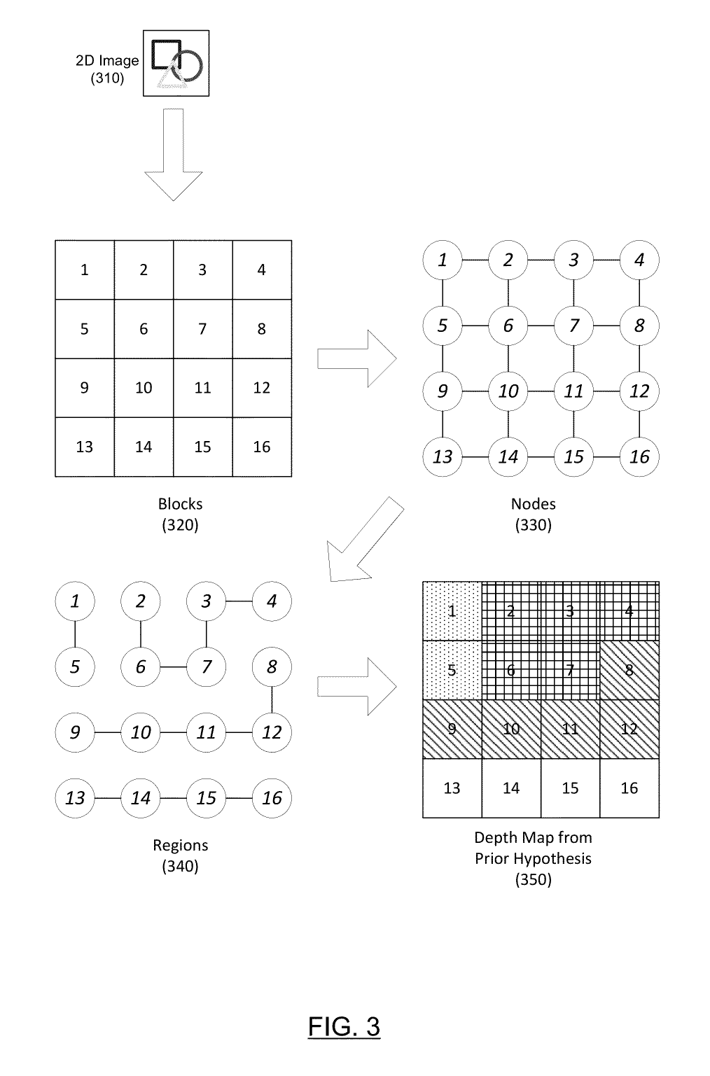

To further illustrate the operations of the depth map generator 240, FIG. 3 illustrates an example of generating a filtered depth map from a 2D image. A 2D image 310, which may correspond to the 2D image 210 of FIG. 2, may be partitioned into blocks 320. Each of the 16 blocks may include 4-by-4 pixels, and in one implementation, the pixels in the same block may be associated with the same depth value. The blocks 320 may then be converted to a 4-by-4 graph, in which each of the nodes 330 may be connected to one another by links.

The region generation module 223 of FIG. 2 may be configured to determine the above-threshold-value link values, indicative of strong edges, and remove such links to generate regions 340. Specifically, in the illustrated example shown in FIG. 3, 12 links are removed (i.e., the links between node 1 and node 2, between node 2 and node 3, between node 5 and node 6, between node 7 and node 8, between node 4 and node 8, between node 5 and node 9, between node 6 and node 10, between node 7 and node 11, between node 9 and node 13, between node 10 and node 14, between node 11 and node 15, and between node 12 and node 16.)

Suppose the bottom-to-top depth gradient hypothesis is selected. A depth map 350 is determined based on the selected hypothesis. In this illustrated example, because there are four different regions, there are four different depth values (represented by different patterns in FIG. 3) for the four different regions. The depth map 350, after filtering, may then be used to convert the 2D image 310 into an image for 3D visualization using a known Depth-Image-Based Rendering (DIBR) approach.

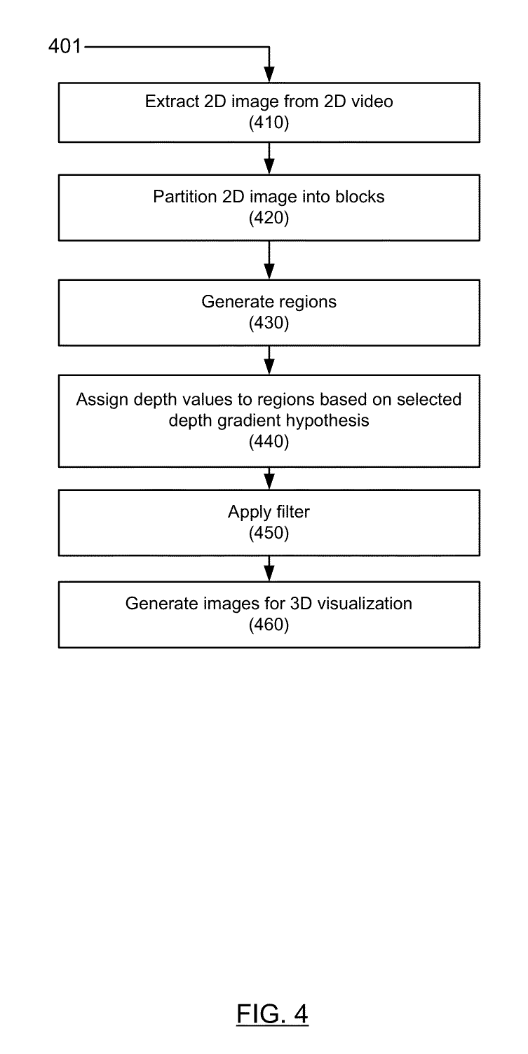

FIG. 4 shows a flow diagram of an illustrative embodiment of a process 401 for converting a 2D image to a 3D image. The process 401 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 4 may be practiced in various implementations. In some embodiments, machine-executable instructions for the process 401 may be stored in memory, executed by a processing unit, and/or implemented in the image conversion system 120 of FIG. 1.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

At block 410, a video decoder of an image conversion system (e.g., the video decoder 130 of FIG. 1) may receive a 2D video as inputs, which may be a sequence of single-view video frames. The video decoder may decode the 2D video and extract one or more 2D images from the 2D video. The 2D image may be transmitted to a depth map generator of the image conversion system (e.g., the depth map generator 140). At block 420, the depth map generator may partition the 2D image into blocks, wherein each block includes a number of pixels.

In one implementation, to utilize a graph-based segmentation approach, the depth map generator may determine the color differences and the connectivity among the partitioned blocks and use such information to establish a corresponding set of nodes, connected by links each having a link value. At block 430, the depth map generator may remove a set of links having above-threshold-value link values to generate one or more regions.

At block 440, the depth map generator may assign depth values to the generated regions based on the selected depth gradient hypothesis. In one implementation, the selection of the depth gradient hypothesis is based on the outcome of a geometric perspective analysis of the 2D image.

At block 450, the depth map generator may apply a filter to the depth map capturing the assigned depth values to the regions to remove potential blocky artifacts but preserve the depth discontinuities along object boundaries.

At block 460, with the filtered depth map, a conversion engine of the image conversion system (e.g., the conversion engine 150) may use DIBR to generate images for 3D visualization.

According to a set of experimental results, the computational complexity of the process 401 is determined to be O(e^{5|E|-5n}), where n denotes the number of blocks, and |E| denotes the number of edges. This may imply that a larger number of blocks correspond to a longer computational time since the MST segmentation algorithm is known to have a highly sequential dependency. However, because one embodiment of the process 401 may be configured to select a depth gradient hypothesis, instead of integrating several computationally extensive depth cues, the process 401 can be operated efficiently while yielding slight side effects.

Thus, methods and systems for performing image conversion using edge information have been described. The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or firmware to implement the techniques introduced here may be stored on a non-transitory machine-readable storage medium and may be executed by one or more general-purpose or special-purpose programmable microprocessors. A “machine-readable storage medium” or “machine-readable medium,” as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). Some examples of a machine-readable storage medium may include, without limitation, recordable/non-recordable media (e.g., read-only memory (ROM), solid-state non-volatile semiconductor memory, random access memory (RAM), magnetic disk storage media, optical storage media, flash memory devices, solid state drive, etc.)

Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense.

We claim:

1. A method of generating a depth map from a two-dimensional (2D) image, comprising:
partitioning the 2D image to generate a plurality of blocks;
segmenting the plurality of blocks into a group of regions based on edges determined in the plurality of blocks;
assigning depth values to the plurality of blocks based on a depth gradient hypothesis associated with the group of regions, wherein pixels in each of the plurality of blocks are associated with a same depth value; and
generating the depth map based on the depth values of the plurality of blocks.

2. The method as recited in claim 1, further comprising:
applying a filter to the depth map, wherein the filter has characteristics of smoothing the depth map while preserving depth discontinuities along object boundaries in the 2D image.

3. The method as recited in claim 1, further comprising:
converting the 2D image to a 3-dimensional image using the depth map.

4. The method as recited in claim 1, wherein the segmenting the plurality of blocks into the group of regions comprising:
assigning a link value to a link connecting each pair of neighboring blocks in the plurality of blocks based on an edge determined between the each pair of neighboring blocks; and
removing a set of links from a plurality of links connecting the plurality of blocks, wherein the set of links correspond to relatively strong edges among the plurality of links.

5. The method as recited in claim 4, wherein the link value is based on a color difference between the each pair of neighboring blocks.

6. The method as recited in claim 1, wherein the assigning depth values to the plurality of blocks comprising selecting the depth gradient hypothesis based on a geometric perspective of the 2D image.

7. The method as recited in claim 6, wherein determining the geometric perspective of the 2D image involves a line detection mechanism.

8. The method as recited in claim 6, wherein the depth gradient hypothesis is selected from a top-to-bottom depth gradient hypothesis, bottom-to-top depth gradient hypothesis, left-to-right depth gradient hypothesis, right-to-left depth gradient hypothesis, bottom-left-to-top-right depth gradient hypothesis, and bottom-right-to-top-left depth gradient hypothesis.

9. A machine readable medium containing instructions for generating a depth map from a 2-dimensional (2D) image, which when executed by a processing unit, causes the processing unit to:
partition the 2D image to generate a plurality of blocks;
segment the plurality of blocks into a group of regions based on edges determined in the plurality of blocks;
assign depth values to the plurality of blocks based on a depth gradient hypothesis associated with the group of regions, wherein pixels in each of the plurality of blocks are associated with a same depth value; and
generate the depth map based on the depth values of the plurality of blocks.

10. The machine readable medium as recited in claim 9, further containing additional instructions, which when executed by the processing unit, causes the processing unit to apply a filter to the depth map, wherein the filter has characteristics of smoothing the depth map while preserving depth discontinuities along object boundaries in the 2D image.

11. The machine readable medium as recited in claim 9, further containing additional instructions, which when executed by the processing unit, causes the processing unit to convert the 2D image to a 3-dimensional (3D) image using the depth map.

12. The machine readable medium as recited in claim 9, further containing additional instructions for the segmenting of the plurality of blocks into the group of regions, which when executed by the processing unit, causes the processing unit to:
assign a link value to a link connecting each pair of neighboring blocks in the plurality of blocks based on an edge determined between the each pair of neighboring blocks; and
remove a set of links from a plurality of links connecting the plurality of blocks, wherein the set of links correspond to relatively strong edges among the plurality of links.

13. The machine readable medium as recited in claim 12, wherein the link value is based on a color difference between the each pair of neighboring blocks.

14. The machine readable medium as recited in claim 9, further containing additional instructions for the assigning of the depth values to the plurality of blocks, which when executed by the processing unit, causes the processing unit to select the depth gradient hypothesis based on a geometric perspective of the 2D image.

15. The machine readable medium as recited in claim 14, wherein determining the geometric perspective of the 2D image involves a line detection mechanism.

16. The machine readable medium as recited in claim 14, wherein the depth gradient hypothesis is selected from a top-to-bottom depth gradient hypothesis, bottom-to-top depth gradient hypothesis, left-to-right depth gradient hypothesis, right-to-left depth gradient hypothesis, bottom-left-to-top-right depth gradient hypothesis, and bottom-right-to-top-left depth gradient hypothesis.

17. A method for converting a two-dimensional (2D) video to a three-dimensional (3D) video, comprising:
selecting a 2D image from the 2D video;
partitioning the 2D image to generate a plurality of blocks, wherein each pair of the plurality of blocks is connected by a link having a link value;
segmenting the plurality of blocks into a group of regions based on the link values;
assigning depth values to the plurality of blocks by applying a depth gradient hypothesis associated with the group of regions; and
generating the depth map based on the depth values of the plurality of blocks; and
converting the 2D image to a 3D image for the 3D video using the depth map.

18. The method as recited in claim 17, further comprising:
applying a filter to the depth map prior to the converting the 2D image to the 3D image, wherein the filter has characteristics of smoothing the depth map while preserving depth discontinuities along object boundaries in the 2D image.

19. The method as recited in claim 17, wherein the segmenting the plurality of blocks into the group of regions comprises:
removing a set of links from a plurality of links connecting the plurality of blocks, wherein the set of links correspond to relatively strong edges among the plurality of links.

20. The method as recited in claim 10, wherein the assigning depth values to the plurality of blocks comprises selecting the depth gradient hypothesis based on a geometric perspective of the 2D image.
